(19) United States
(12) Patent Application Publication
(10) Pub. No.: US 2014/0025437 A1
(43) Pub. Date: Jan. 23, 2014

(54) SUCCESS GUIDANCE METHOD, APPARATUS, AND SOFTWARE

(71) Applicant: QUOSAL, LLC, Bothell, WA (US)

(72) Inventors: KENT S. MCNALL, WOODINVILLE, WA (US); SAMUEL G. DEMULLING, SNOHOMISH, WA (US)

(21) Appl. No.: 13/942,679

(22) Filed: Jul. 15, 2013

Related U.S. Application Data
(60) Provisional application No. 61/671,625, filed on Jul. 13, 2012.
(60) Provisional application No. 61/671,671, filed on Jul. 13, 2012.

(51) Int. Cl. G06Q 10/06

(52) U.S. Cl. CPC G06Q 10/0637; G06Q 10/06393
USPC 705/7.36; 705/7.39

(57) ABSTRACT

A success guidance software program is configured to provide one or more indications to a user regarding compliance of a particular campaign of a class of campaigns with a plurality of actions and action attributes associated with a successful outcome for campaigns of the class. The success guidance software may be geared toward scalable sales-like efforts, and particularly toward sales-like efforts having independently verifiable actions and action attributes.

### CROSS-REFERENCE TO RELATED APPLICATIONS

The present application claims priority benefit from U.S. Provisional Patent Application No. 61/671,625, entitled “SUCCESS GUIDANCE METHOD, APPARATUS, AND SOFTWARE”, filed Jul. 13, 2012, and U.S. Provisional Patent Application No. 61/671,671, entitled “SUCCESS GUIDANCE METHOD, APPARATUS, AND SOFTWARE”, filed Jul. 13, 2012; which are incorporated by reference in their entireties.

### SUMMARY

According to an embodiment, a success guidance software program is configured to provide one or more indications to a user regarding compliance of a particular campaign with a plurality of model events and/or event attributes associated with a successful outcome for similar (model) campaigns. For example, the campaign may be classified by model type, and the model events, event attributes and/or time parameters for the campaign model type may be provided by a success model vendor, by a campaign manager, and/or responsive to statistical outcomes of prior campaigns of the type.

For example, the success guidance software may be geared toward scalable sales-like efforts, and particularly toward sales-like efforts having independently verifiable events and/or independently verifiable event attributes.

According to an embodiment, a computer system is configured to provide campaign success guidance to a user. The computer system includes a server computer including a network interface configured to communicate with other computers. In particular, the server computer is configured to communicate with a client computer configured to run client software application operable to communicate with the server computer via a computer network. Computer memory or a computer storage medium operatively coupled to the server computer may be configured to carry a campaign model including events corresponding to a campaign undertaken by a user. A success guidance engine operatively coupled to the network interface and the computer memory or computer storage medium carrying the campaign model may be configured to receive data corresponding to an actual campaign event via the network interface, and compare one or more actual event parameter(s) and/or one or more actual time parameter(s) to corresponding model parameters included in the campaign model. The success guidance engine may then determine a campaign status and cause display of campaign success guidance corresponding to the campaign status by the client computer to the user.

According to another embodiment, a computer system configured to provide campaign success guidance to a user may include a client computer configured to run client software application including a success guidance engine. Computer memory or a computer storage medium operatively coupled to the client computer may be configured to carry a campaign model including events corresponding to a campaign undertaken by a user. The success guidance engine may be configured to receive data corresponding to an actual campaign event and compare actual campaign event parameter(s) and/or time parameter(s), and compare the actual parameter(s) to corresponding model parameters included in the campaign model. For example, the received data may correspond to a verifiable event. The success guidance engine may determine a campaign status as a function of the comparison and cause display of campaign success guidance corresponding to the campaign status by the client computer to the user.

According to an embodiment, a campaign success guidance computer method may include observing or receiving one or more reports of at least one event corresponding to a campaign, comparing the at least one event corresponding to the campaign to a plurality of model events corresponding to a campaign model, and displaying success guidance based on compliance of the at least one event to the model events.

According to an embodiment, a non-transitory computer readable medium may carry computer executable instructions configured to cause a computer to execute steps including observing or receiving one or more reports of at least one event corresponding to a campaign, comparing the at least one event corresponding to the campaign to a plurality of model events corresponding to a campaign model, and displaying success guidance based on compliance of the at least one event to the model events.

### BRIEF DESCRIPTION OF THE DRAWINGS

FIG. 1 is a conceptual model of a campaign showing events corresponding to a successful campaign outcome, according to an embodiment.

FIG. 2 is a conceptual model of an illustrative sales campaign showing illustrative events corresponding to a successful campaign outcome, or sale, according to an embodiment.

FIG. 3 is a diagram of a client-server network configured to provide success guidance to a user, according to an embodiment.

FIG. 4 is a diagram of a client-server network configured to provide success guidance to a user, according to another embodiment.

FIG. 5 is a flow chart showing a method for providing success guidance to a user, according to an embodiment.

FIG. 6 is a depiction of a user interface home screen displayed to a user of the success guidance software described above, according to an embodiment.

FIG. 7 is a depiction of a user interface campaign success guidance screen displayed to a user of the success guidance software describe above, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

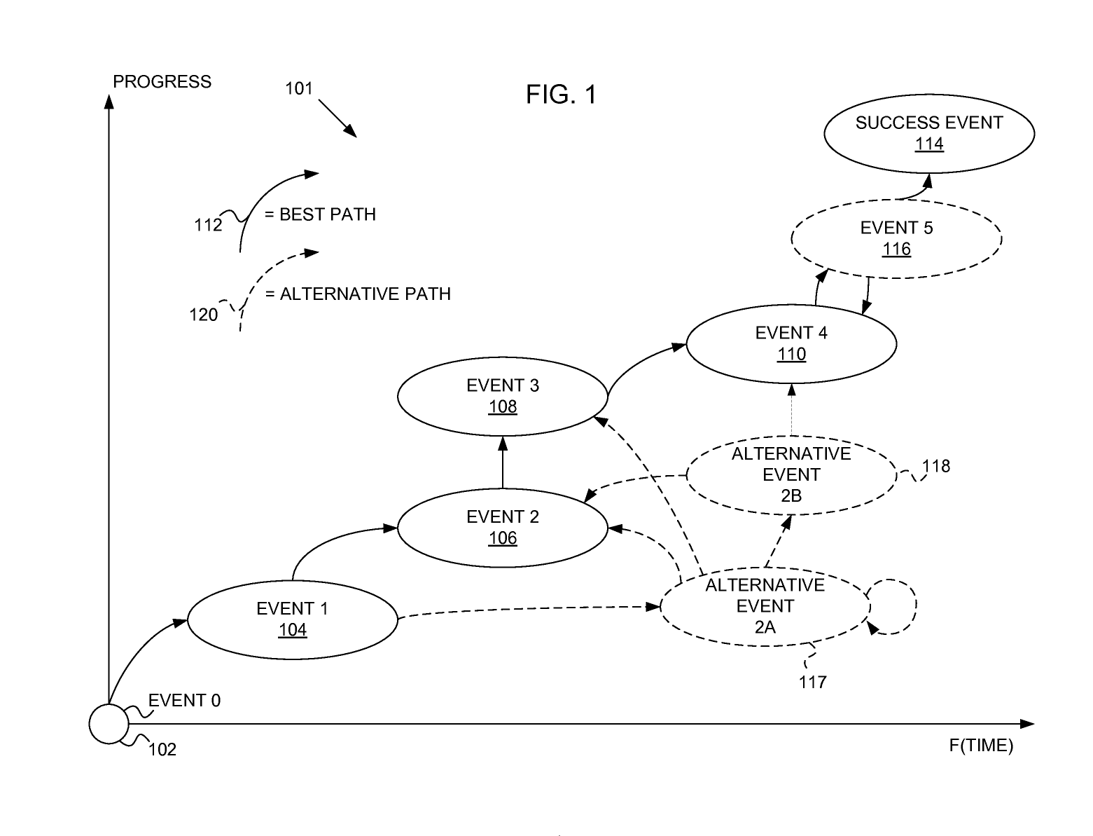

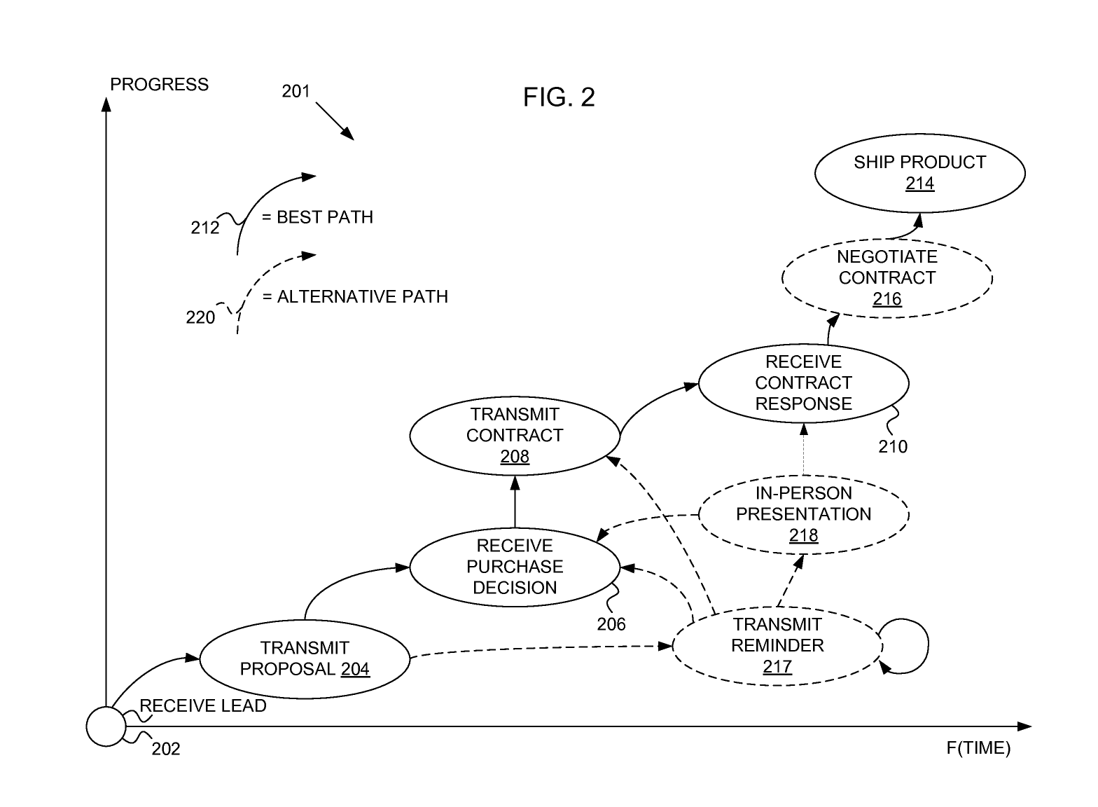

FIG. 1 illustrates a series of steps corresponding to a campaign model 101 showing events corresponding to a successful campaign outcome or success event 114, according to an embodiment. The campaign model 101 represents an effort including plural events. The model effort has a positive or negative outcome. Most particularly, the campaign model 101 includes events in a predetermined path to success, and parameters for positive outcome of the events in the predetermined path. For example, an event 1 104 may be determined to result in a best result (e.g., progressing to a next event, event 2 106, in the campaign model 101) when performed within a tolerance around a nominal time after an initiation event 0 102. This will be more fully explained below and with reference to FIGS. 1 and 2.

The campaign model 101 corresponds to a class of campaigns having similar events, event attributes, event sequence, time parameters, and/or sensitivity to campaign variables (“campaign variables” are described more thoroughly below). The campaign model 101 includes nominal events and event sequence 102, 104, 106, 108, and 110, along a best path 112 (which may also be referred to as a nominal path 112) from the initiation event 102 through the success event 114.

The campaign model 101, including the nominal events 102, 104, 106, 108, 110 and the best path 112, are shown plotted as progress versus a function of time. There is no particular scale in this diagrammatical description, but the succession of nominal events 102, 104, 106, 108, and 110 along the best path 112 generally occur over finite times and with some nominal delay and tolerance along the x-axis. The scale of the x-axis corresponds to a time parameter associated with respective pairs of events and/or associated with the entire campaign 101. The time parameter may include an elapsed clock time, an elapsed calendar time, a scheduled clock time, a scheduled calendar date, and/or a seasonality-adjusted calendar date, for example. The nominal events 102, 104, 106, 108, and 110 also seek to advance the cause of the campaign, and are shown as nominally ascending toward completion at the success event 114. Campaign progress may include an arbitrary measure of the convergence of a campaign 101 toward the success event 114. According to embodiments, the vertical axis may be calculated as an estimated work effort completion, a reduction in risk, an increase in present value, a probability of reaching the success event 114, or other measure of “goodness.”

Event attributes and/or event parameters can correspond to a verifiable event or a non-verifiable event. A verifiable event (also referred to as an independently verifiable event) includes an event where at least the occurrence of the event is received by the success guidance method, software, or system without user intervention. It is contemplated that verifiable events may usually also have verifiable event parameters.

A verifiable event may include delivery or receipt of a document to analyze, a simple indicator of occurrence, feedback from a sensor or sensor network, video, audio, SMS, etc. A verifiable event is generally generated by an independent data source. A non-verifiable event may include an event whose existence (and any parameters) is not received automatically. For example a non-verifiable even could be entered by a user, reported by an external (non-captive) system, or included in a report by a supervisor.

A non-verifiable event datum generally is not received via an independent data source. The term “independent data source” is intended to mean a data source other than a user interface configured to receive user (non-verifiable) data entry. A non-verifiable event can include an event datum and/or event parameters that are reported by a person, such as the user.

Non-independently verifiable events can be inherently less trustworthy than independently verifiable event data. Nevertheless, value can be delivered if the user is truthful with the success guidance software. Embodiments of the success guidance software accept and generate success guidance from non-independently verifiable event data. Some embodiments of the success guidance software apply a weighting to data corresponding to independently verifiable events vs. data corresponding to non-independently verifiable event data, particularly with respect to success guidance model selection. Some embodiments of the success guidance software analyze non-independently verifiable data with respect to a set of truthfulness probability tables. Some embodiments of the success guidance software analyze success outcomes as a function of non-independently verifiable event data to determine a truthfulness probability for the user. The inventors contemplate that truthfulness probability data can be encrypted and/or can otherwise be guarded on behalf of the user or a licensed organization.

Time parameters include seconds, minutes, hours, days, weeks, months, or years between events, depending on the type of campaign being mounted and/or a phase in a repeating campaign. The term “time parameter” may be understood to include uncertainty measures, ranges of time, bar dates, calendar dates, or seasonality, for example. Actual time parameters corresponding to actual execution (or non-execution) of events may be independently verifiable or non-independently verifiable.

Some campaign models may differ primarily with respect to time parameters. Some campaign models may differ primarily with respect to event parameters. Other campaign models may differ with respect to both time and event parameters. Specific campaign environments may generally include specific event content. Titles may vary by usage at a client organization or in a client industry; for example, duties (event parameters) associated with an event may vary by person, by position, etc.

Events, event attributes, event sequences, and time parameters of a campaign may be referred to as campaign variables.

A campaign success guidance engine or campaign success guidance software may determine a campaign status as a function of campaign variables. Ideally, the campaign status is achievement of a “success event” or “compliance” with the predetermined campaign model. In compliance, there is sufficient similarity of events, event sequence, event attributes, and time parameters of the particular campaign to a campaign model to assign a state or probability that the campaign is under control and there is no known intervention necessity (no known fires to put out).

Still referring to FIG. 1, a best path sequence 112 progresses from event 0 102 through event 1 104, event 2 106, event 3 108, and event 4 110, to the success event 114 is shown joined by solid arrows. Each event represents in the campaign model 101 corresponds to a measurable (independently verifiable or non-independently verifiable) event occurrence that relates an actual campaign to the campaign model 101. An event initiated by a user is referred to as an action event. An event initiated by a customer is referred to as an input event or a response event. Events 1-4 104, 106, 108, and 110 are to be regarded as nominal events in a campaign model 101 including the success event 114. Each of events 1-4 104, 106, 108, and 110 is regarded as one of a plurality of “ideal” or “nominal” events representing a “best” or “nominal” path to success event 114. The best path 112 (shown as solid arrows) may be determined as a sequence of events corresponding to a shortest duration campaign, a lowest effort campaign, a campaign having a measurable best outcome, or a campaign having highest certainty of successful outcome. A given campaign model has a particular best path. Model variants may be selected to have differing predetermined best paths corresponding to what is considered best by the user or the user's management.

Event 1 104, event 3 108, and event 4 110 may be regarded as mandatory events. A mandatory event may occur in substantially or literally all successful campaigns.

A non-mandatory event may occur in some successful campaigns. For example, event 5 116 may represent a non-mandatory event that has little effect on outcome. The best path 112 can travel through or past event 5 116.

Other non-mandatory events may reset a time parameter or campaign progress, may cause reversion to an earlier mandatory event or another event that becomes mandatory responsive to the non-mandatory event.

For example, if event 2 106 does not occur within an allowable length of time (according to a nominal time parameter associated with the pair of events event 1 104 and event 2 106), an alternative campaign model may load and indicate an alternative event 2A 117. The alternative event 2A 117 may include an event identified by the campaign model 101 as not lying on the best path 112, but which can correct a campaign that has diverged from the best path 112. The divergence may occur as a result of non-compliance with respect to non-occurrence of an event, an out-of-sequence event, a non-ideal event attribute, or a non-ideal time parameter. An alternative path may be regarded as a sequence of events including one or more alternative events that preserves the opportunity for the campaign model 101 to result in the success event 114.

As shown by dashed “alternative path” arrows 120, receiving a report of or detecting execution of event parameters associated with the alternative event 2A may revert the actual campaign to correspond to event 2 106, shown as nominally further progressed from the alternative event 2A 117, but with a time scale reversion. Upon receipt and processing of the event parameters, another campaign model (such as the original campaign model) may be loaded to properly cause indication of a need to almost immediately execute event 3 108.

Alternatively, second event parameter(s) returned from the alternative event 2A 117 can indicate actual campaign reversion to event 3 108, upon which the original campaign model is again loaded, this time showing status as corresponding to event 3 108. The second event parameter(s) corresponding to the alternative event 2A 117 may nominally be considered “better” because event 3 108 corresponds to more advanced campaign progress.

Still other, third event parameter(s) may cause the success guidance engine to load a campaign model including an alternative event 2B 118. As described above, this does not require literally loading a new campaign model—the alternative event 2B 118 may be invoked in the current model responsive to receiving campaign variables (i.e., second event parameters) indicating the alternative event 2B 118. As shown by the dashed “alternative path” arrows 120 to event 2 106 and event 4 110, event parameters or variables corresponding to execution (or non-execution) of the alternative event 2B 118 may result in two paths, each to a nominal event 2 106 and 4 110. Progression to event 4 110 may be considered onward and upward, while regression to event 2 106 may be regarded as a setback. Various types of user interface (UI) indications may be made to the user responsive to various campaign paths.

Logically, the relationship(s) between the nominal events 104, 106, 108, and 110 and alternative events 117, 118, and paths therebetween, may be considered referenced campaign models. Referenced campaign models may typically be related to one another by alternative paths 120.

Generally, a target respondent of the campaign is referred to as a customer. Customers may include a single person or may include an organization, sometimes with constituencies that interrelate with a campaign and/or a campaign model at various events 102, 104, 106, 108, 110, and 114 (and/or at various non-nominal or alternative events 116, 117, and 118).

The success event 114 generally refers to a successful campaign outcome. The success event 114 may include an intended measurable response to the campaign by the customer. The measurable response can include a click, a sale, a vote, a lease, a contract, etc.

According to embodiments, the campaign model 101 may include event weighting. Event weighting may include a measure of sensitivity of a campaign model to performance, sequence, attributes or parameters, and time parameters corresponding to a given event or sequence of events.

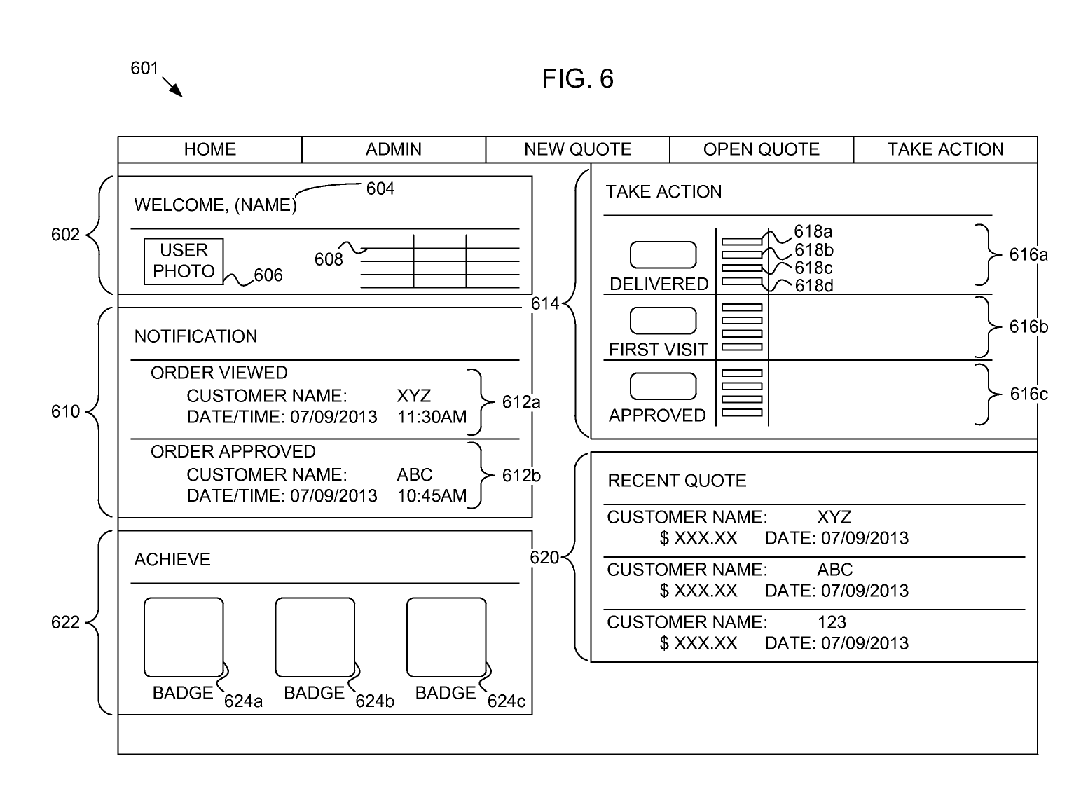

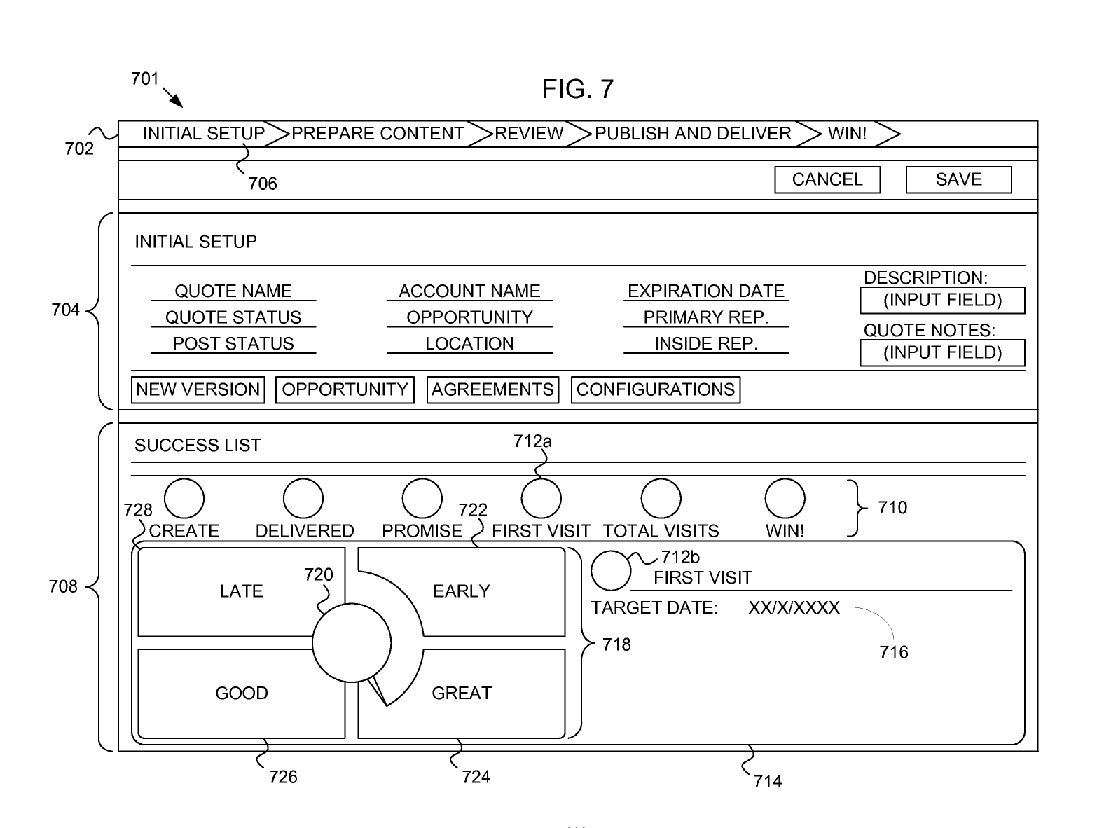

As will be described more fully below, one primary purpose of the campaign model 101 and comparison of actual campaign events to the campaign model 101 by a success guidance engine may be to provide success guidance. Success guidance includes providing one or more indications to the user indicative of compliance of a current campaign to a successful campaign outcome for the campaign model 101. Success guidance can also include one or more indications to a user including a plan or schedule for upcoming events. The indication(s) can include a sensible computer output to the user, such as a graphical display. In some embodiments, the indication(s) can include other communication or alert modalities. FIGS. 6 and 7 illustrate formats of success guidance information provided to a user.

Still referring to FIG. 1, a secondary purpose of the campaign model 101 and comparison of actual campaign events to the campaign model by a success guidance engine can include providing a failure warning. Failure warnings can include one or more indications to the user indicative of non-compliance of a current campaign to a successful campaign outcome for the campaign model or an alternative (referenced) campaign model 101. For example, a fail warning may be used by a user in a decision regarding abandonment of the actual campaign.

FIG. 2 illustrates a series of steps corresponding to a sales campaign 201 showing illustrative actions corresponding to a successful campaign outcome, or sale, according to an embodiment. The sales campaign model 201 is an example of a particular type of campaign, compared to the generic campaign model 101 illustratively depicted in FIG. 1.

In the sales campaign model 201 of FIG. 2, the events that are associated with the selling of a product are plotted as progress toward a successful outcome (on the vertical axis) versus a function of time (on the horizontal axis). There is no particular scale in this diagrammatical description, but the events generally occur over finite times and with some allowable delay between them. The scale of the x-axis may indicate a time parameter associated with respective pairs of events and/or associated with the entire sales campaign model 201. At any point in the progress of the model, the time parameter may correspond to, for example, an elapsed clock time, an elapsed calendar time, a scheduled clock time, a scheduled calendar date, and/or a seasonality-adjusted calendar date. Time parameters may include uncertainty measures, ranges of time, bar dates, calendar dates, or seasonality, for example. The progress parameter on the vertical axis may correspond, for example, to a percentage of completion of a sales effort or to some other measure of progress or goodness.

The campaign initiation event for the sales campaign model 201 is the receipt of a sales lead by an organization, and the positive success event 214 is the subsequent shipment of a product to a customer. Event 202 corresponds to the receipt of a sales lead by the organization. According to the sales campaign model 201, the best path 212 for the sales effort is a progression from receipt 202 of the sales lead to a transmission 204 of a proposal to the customer identified in the sales lead, followed by a receipt 206 of a purchase order from the customer, a transmission 208 of a contract to the customer, and a receipt 210 of a contract response from the customer. Assuming that the customer's response to the contract is positive, the sales campaign model 201 proceeds directly to a success event 214, the shipment of the product to the customer. This sequence of events may be regarded as the best path 212 for the sales campaign model 201 based on its having the shortest duration, having the lowest cost, requiring the least effort, or other criterion including combinations of criteria.

A number of conditions may occur that cause the sales effort to deviate from the best path 212 (indicated by solid arrows in FIG. 2) onto one of the alternative paths 220 (indicated by dashed arrows in FIG. 2). For example, if the customer does not respond to the proposal transmitted in event 204 within a time period predetermined for the sales campaign 201 (such as one week, for example), the sales effort can proceed, according to the sales campaign model 201, to an event 217, transmitting a reminder of the proposal to the customer. The one-week interval is considered a time parameter relating events 204 and 206 of the sales campaign model 201.

The loopback arrow on event 217, the transmission of a reminder to the customer, indicates that this event may be performed multiple times. The sales campaign model 201 includes one or more time parameters and/or event parameters associated with the repeated transmission 217 of the reminder. For example, the second reminder is best transmitted five days after the first reminder, and if there is no response from the customer, the third reminder is best transmitted two days after the second reminder. Particular time parameters are predetermined according to cross correlation of previous event parameters to successful campaign outcomes. The sales campaign model 201 includes other parameters. For example if no response from the customer is received within two weeks of the transmission of the third reminder, the sales effort can be terminated (with an unsuccessful outcome), or alternatively, a different sales model may be loaded corresponding to a different series of events in an attempt to complete the sale.

According to the sales campaign model 201, transmission of the reminder 217 can be followed by one of three events 206, 208, or 218. In event 206, the customer purchase order is received, and the sales effort is considered back on track, since it now proceeds along the best path 212. If the reminder transmission 217 leads to event 208, a sales contract is transmitted to the customer. Again, the sales effort has been restored to the best path 212, and in this case is closer to successful completion than event 206. The third possible alternative path 220 leading from reminder transmission 217 is event 218, an in-person presentation to the customer, which is regarded as a “last ditch” effort to make the sale.

According to the sales campaign model 201, the in-person presentation 218 has two alternative paths 220 to subsequent events. The first alternative path 220 leads to event 206, receiving a purchase order from the customer. Although this path returns the progress in the sales effort to the best path 212, it is considered a setback since it reverts to a relatively early phase of the sales effort. The second alternative path 220 from the in-person presentation 218 leads to event 210, receiving a contract response from the customer. This event 210 also lies on the best path 212, but is significantly farther along in the sales campaign model 201 than is event 206, receiving the purchase order, and thus is considered a preferred outcome of the in-person presentation 218.

After receiving the contract response 210 from the customer, the campaign can proceed, if required by the contract response, to non-mandatory event 216, negotiation of the contract, and thence to the success event 214, shipment of the sold product. If no negotiation is required, the campaign proceeds directly from event 210 to the success event 214, shipment of the sold product.

It will be appreciated that the sales campaign model 201 is not the only possible model for a sales effort. An organization may maintain a plurality of different sales campaign models, and may select, either automatically or manually, which model to apply in a given sales situation based on such factors as, for example, management's judgment of the most appropriate model, the nature, size, and anticipated profitability of the prospective sale, the product or products being sold, competitive factors, time constraints, and so forth. In addition, events or other factors that may occur during the application of one model may indicate that a switch to a different model may be advantageous. For example, if it is discovered that a potential sale is smaller or less profitable than originally expected, an alternative sales campaign model is activated that includes fewer costly or time-consuming events.

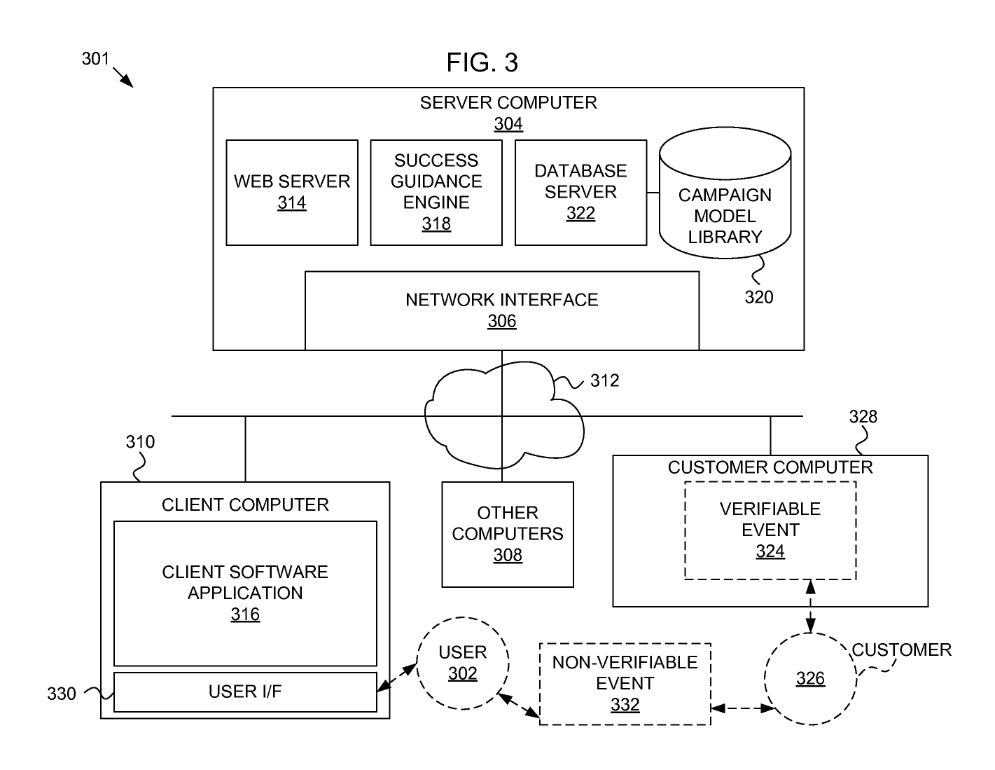

FIG. 3 is a diagram of a client-server network 301 configured to provide campaign success guidance to a user 302, according to an embodiment. At least one server computer 304 includes a network communication interface 306 configured for communication with other computers 308 including a client computer 310 across a communication network 312. A web server 314 is operatively coupled to the at least one server computer 304 and configured to interface with a client software application 316 running on the client computer 310. A success guidance engine 318 is operatively coupled to the web server 314 and the client software application 316. As shown in the depiction of FIG. 3, the success guidance engine 318 is configured to run on at least one server computer 304 and is configured to communicate with the client software application 316 via the server computer network communication interface 306 and the communication network 312. For example, the success guidance engine 318 can include an application that runs on an operating system of the server computer 304 and which communicates with the web server 314, which may be in the form of another application running on the operating system of the server computer 304. Alternatively, the success guidance engine 318 can be configured as an application that runs on the web server 314, such as via an application programming interface (API) for the web server 314.

A campaign model library 320 is operatively coupled to the success guidance engine 318 via a database server 322. The campaign model library 320 is carried by a non-transitory computer-readable medium, and includes data corresponding to one or more campaign models, such as campaign models illustratively depicted by FIGS. 1 and 2. The campaign model 101 to a success event 114 includes steps and parameters for progressing from a campaign initiation 102 (also referred to as “Event 0”), through a sequence of nominal events 104, 106, 108, and 110 along a best path 112 to the success event 114. The campaign model library 320 can also hold computer-readable data corresponding to one or more alternative campaign models 101 including one or more alternative events 116, 118 along one or more alternative paths 120 toward the success event 114. As used herein, references to loading an alternative campaign model responsive to a non-nominal event parameter (e.g., a non-nominal time parameter) can include retrieving an alternative campaign model from the campaign model library 320 and loading the alternative campaign model into a computer memory operatively coupled to the server computer 304 and the success guidance engine 318. Alternatively, loading the alternative campaign model can include setting a pointer to a corresponding alternative campaign model carried by the computer storage medium or computer memory that carries the campaign model library 320. For example, the alternative campaign model corresponds to the current campaign model except for replacement of a best path 112 between the nominal events 102, 104, 106, 108, 110, and 114 by an alternative path 120 including the alternative events 116, 118. It will be understood that, in practice, such loading of an alternative campaign model may additionally or alternatively correspond to selecting a new variable value for a single campaign model, the new variable value activating at least a portion of an alternative path 120 in place of at least a portion of a best path 112.

According to an embodiment, success guidance engine logic reads independently verifiable event data, and automatically loads an alternative campaign model that best corresponds to the independently verifiable event data.

Referring again to FIG. 3, the computer system 301 is configured to provide campaign success guidance to a user 302. The computer system 301 includes at least one server computer 304 including a network interface 306 configured to communicate with other computers 308 which include the client computer 310. The client computer 310 is configured to run the client software application 316 operable to communicate with the server computer 304 via the communication network 312.

Computer memory (not shown) or a computer storage medium holding the campaign model library 320 is operatively coupled to the at least one server computer 304 and configured to carry a campaign model including events corresponding to a campaign undertaken by the user 302. The server computer 304 includes a success guidance engine 318 operatively coupled to the network communication interface 306 and the computer memory (not shown) or computer storage medium holding the campaign model library 320 carrying the campaign model. The success guidance engine 318 is configured to receive data corresponding to an actual campaign event via the network communication interface 306 (either as independently verifiable events or as non-independently verifiable events, such as events entered by the user), compare one or more actual event parameters (e.g. actual time parameters) to corresponding model parameters included in the campaign model. From the actual-to-model parameter comparison, the success guidance engine 318 determines a campaign status. The success guidance engine 318 then causes display of campaign success guidance corresponding to the campaign status by the client computer 310 to the user 302.

The success guidance engine 318 is configured to receive data corresponding to a verifiable campaign event 324, such as the presentation of an electronic proposal to a customer 326 by a customer computer or device 328. More particularly, the success guidance engine 318 receives data corresponding to a customer access of a secure web page configured to present the electronic proposal, and infers that the electronic proposal has been presented to the customer 326. Alternatively, the access of the proposal but the customer 326 can be the event tracked by a campaign model. The success guidance engine 318 can also be configured to receive data corresponding to a non-verifiable campaign event 332 from the user 302 via a user interface 330 on the client computer 310 or from another non-verifiable report.

Upon receipt of event data, the success guidance engine 318 pushes a notification of the event to a NOTIFICATION window of a user interface 330 (e.g., see FIG. 6, 610) and updates campaign status. For example, the success guidance engine 318 updates a TAKE ACTION window (e.g., see FIG. 6, 614) to move the relevant campaign to a new status (e.g. a “too soon” status) of the next event in the campaign. The success guidance engine 318 further updates data corresponding to a graphical target parameter (e.g., see FIG. 7, 718) to indicate the new campaign status. If the event data corresponds to a success event, the success guidance engine 318 updates parameters corresponding to an ACHIEVEMENT window (e.g., see FIG. 6, 622) and if the achievement parameters result in a change of achievement status, pushes an achievement status update via the NOTIFICATION window 610 referenced above.

The success guidance engine 318 is also configured to establish a new campaign. The campaign may, for example, be established automatically when the success guidance engine 318 receives or sniffs a click or submitted inquiry from a customer or potential customer 326. Alternatively or additionally, the success guidance engine 318 is configured to establish the campaign responsive to input from the user 302 received via the user interface 330 in the client computer 310 and the client software application 316, the communication network 312, and the network communication interface 306 of the server computer 304. The success guidance engine 318 may be further configured to select a campaign model 101 corresponding to parameters associated with automatically received data and/or with the input from the user 302. Success guidance engine 318 selection of a given campaign model is made responsive to a best fit of the initial data with predetermined initial data for each campaign model.

In an embodiment, the campaign model 101 of FIG. 1 corresponds to a model of a sales cycle such as the sales campaign model 201 of FIG. 2, for example. For enterprises that sell or service limited product lines or product lines having similar sales cycles, it may be advantageous to use the same campaign model for substantially every sales effort. In this case, establishing a campaign model includes referring to a fixed campaign model, and the success guidance engine 318 is configured to establish at least a starting campaign model that is fixed, such as the “best path” sales campaign model 201 of FIG. 2.

Campaigns are typically initiated by some event, which is referred to as a campaign initiation event. Such a campaign initiation event can carry one or more parameters, and the success guidance engine 318 can be configured to select a campaign model responsive to one or more parameters corresponding to the campaign initiation event.

The success guidance engine 318 is configured to compare actual time elapsed since a preceding actual event corresponding the campaign model to corresponding model time parameter(s) carried by the campaign model 101. The actual elapsed time and model time parameter(s) can include one or more of an elapsed clock time, an elapsed calendar time, a scheduled clock time, a scheduled calendar date, or a seasonality-adjusted calendar date. The model time parameter(s) provide a nominal range of times corresponding to a delay between model events for a best path corresponding to the campaign model 101. The model time parameter(s) can additionally include a nominal range of times corresponding to an elapsed time between model events, wherein at least one of the model events is an alternative model event lying on an alternative model campaign path to the success event 114. The alternative model event may include an action event, for example, that is identified as an alternative to a customer response lying on the best path 112.

The success guidance engine 318 may include an update scheduler or timer, and may be configured to update campaign event parameters received or reported responsive to the update scheduler or timer.

The success guidance engine 318 may be configured to compare parameter(s) of the actual campaign with the corresponding parameter(s) of the campaign model and to operate responsive to the results of the comparison(s). For example, if a time parameter of an actual campaign event is longer than a nominal range of a corresponding time parameter of the corresponding event in a campaign model, the success guidance engine 318 is configured to cause display the campaign and the event in a TAKE ACTION window (e.g., see FIG. 6, 614) of a user interface 330 with a “late” event identifier (e.g., see FIG. 6, 618a). The success guidance engine 318 is further configured to cause display of a target parameter indicator (e.g., as a graphical target parameter indicator (e.g., see FIG. 7, 718) in a campaign screen of a user interface 330) such that the target parameter indicator indicates a “late” status.

The success guidance engine 318 can optionally determine an alternative path and load an alternative campaign model including the alternative path. If the time parameter of the actual campaign is within the nominal range of the corresponding campaign model time parameter, the current campaign model may be maintained.

As an alternative to or in addition to loading an alternative campaign model responsive to a “late” or other out-of-range event parameter, the success guidance engine 318 can load alternative events as suggestions for recovering from the out-of-range event parameter. For example, a user may activate a “help” request in the TAKE ACTION window or in the CAMPAIGN SCREEN, and be presented with suggested “plan B” suggestions for recovering from the out-of-range condition.

The events in the campaign model 101 may each include or refer to one or more corresponding event parameters, which may include, for example, non-completion, completion, receipt, non-receipt, a quoted price, a margin corresponding to a quoted price, correspondence of content to content of a parameter of a previous event, and correspondence of content to model content. The success guidance engine 318 may be configured to determine if an event parameter is within a corresponding nominal campaign model event range and if so to maintain the current campaign model. If the event parameter is outside the nominal campaign model event parameter range, the success guidance engine 318 may determine an alternative path and load an alternative campaign model including the alternative path 120; or, as described above, may make recovery suggestions to the user.

The success guidance engine 318 may be configured to determine the status of a campaign, which may include determining if a time parameter corresponding to a non-executed model event corresponds to a recommendation to execute the non-executed event. For example, if a sales campaign model indicates that it is critical to send a follow-up email to a transmitted quotation within three days (a three-day “hard bar” time parameter), and it has been two days since the quotation was transmitted, the recommendation to execute the follow-up email may be made and, according to embodiments, may be emphasized in a user success guidance screen. Additionally or alternatively, for a critical approaching date, displaying the success guidance may include transmitting an alert to the user via an out-of-band resource such as a text message, a synthesized voice transmission, an email, or other approach that bypasses a normal user interface 330.

Determining campaign status may include determining if an event parameter corresponding to an executed event corresponds to a recommendation to repeat the executed event or to modify the executed event. For example, if an executed event includes sending a quotation to a customer 326, but an actual event did not include a quote for an item in the quoted system, determining campaign status may include recommending modifying the executed event by augmenting the sent quotation with additional quote information about the excluded item.

Determining campaign status may include determining if executed event parameters and non-executed event time parameters fall within respective nominal ranges. Again using the example of a sales campaign, if an executed event includes sending a quotation to a customer 326, and a non-executed event includes sending a follow-up reminder after three days, determining campaign status may include determining that a quotation has been sent but it is not yet time to send the follow-up reminder.

Determining campaign status may include determining if an alternative campaign path, an alternative event, or an alternative campaign path and an alternative event are recommended.

According to an embodiment, the success guidance engine 318 may be configured to cause display of the campaign success guidance by loading a viewable page with one or more indicators of campaign success trajectory, one or more indicators of a next event, one or more indicators of a time parameter associated with a next event, or a combination thereof. According to another embodiment, causing display of the campaign success guidance may include transmitting to a client computer 310 for output to the user 302 one or more indicators of campaign success trajectory, one or more indicators of a next event, one or more indicators of a time parameter associated with a next event, or a combination thereof. According to another embodiment, causing display of the campaign success guidance may include causing display of one or more graphical health icons corresponding to compliance of actual campaign time and/or event parameters to corresponding model campaign time and/or event parameters. A display of this type may be useful for example for quickly verifying visually that the campaign is on track, or that one or more exceptions may be impeding the nominal progress of the campaign.

According to other embodiments, the success guidance engine 318 may be configured to cause display of the campaign success guidance by causing display of one or more graphical comparisons of the actual campaign event placements to model campaign event placements, and/or by causing display of one or more text fields. Particular examples of graphical user interfaces for displaying campaign status are shown in FIGS. 6 and 7.

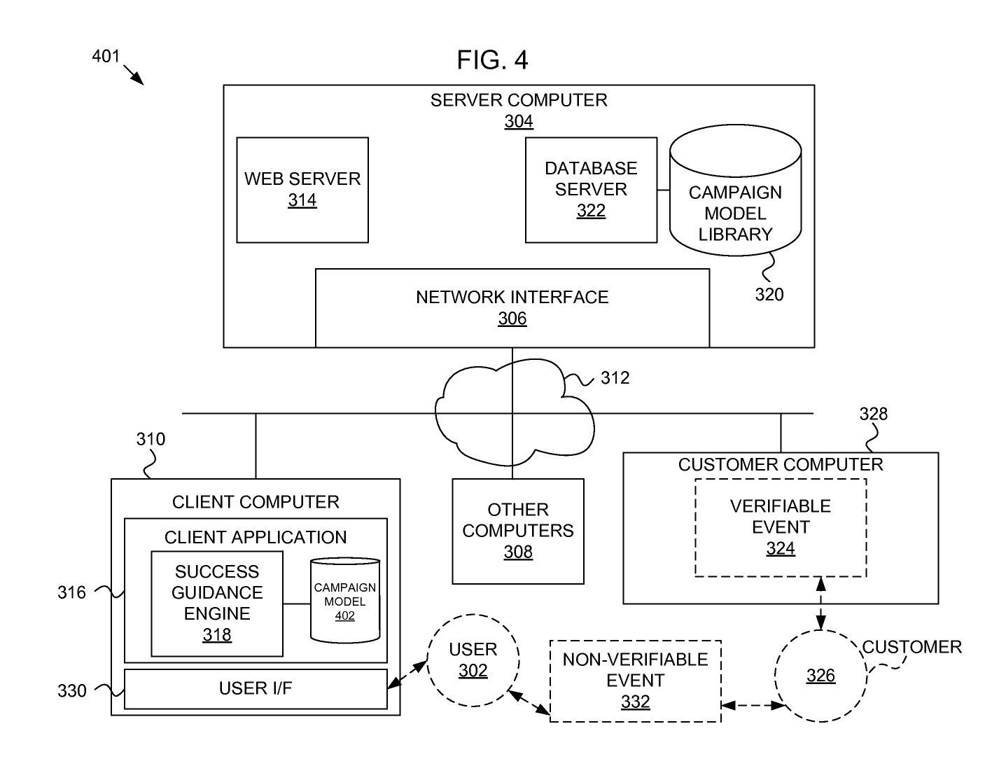

FIG. 4 is a diagram of a client-server network 401 configured to provide success guidance to the user 302, according to another embodiment. According to the embodiment 401, the success guidance engine 318 may be configured to run on the client computer 310, optionally as part of or substantially as the client software application 316. The client-server network 401 may, for example, be most appropriate when the client computer 310 is a conventional desktop, laptop, or tablet computer having an operating system (not shown), local storage (not shown) and, computing resources (not shown) capable of running an application program having the capabilities of the success guidance engine 318. The client-server network 301 may, for example, be most appropriate when the client computer 310 is a less capable computer such as a tablet computer or smart phone, or when the client computer 310 is capable but has an unsupported operating system (not shown). That said, computing architectures and capabilities continue to evolve, and the architectures 301, 401 respectively represented in FIGS. 3 and 4 may be substituted for one another as desired by the system architect. Alternatively, another embodiment (not shown) may include some portions of the success guidance engine 318 being resident on the at least one server computer 304 and other portions of the success guidance engine 318 being resident on the client computer 310. For the server-based success guidance architecture 301 shown in FIG. 3, the success guidance engine 318 may operate on the at least one server computer 304 as the web server 314, or may alternatively be deployed on a different server computer 304.

According to an embodiment, the computer system 401 is configured to provide campaign success guidance to a user 302. The client computer 310 is configured to run client software application 316 including a success guidance engine 318. A computer memory or a computer storage medium is included in the client computer 310 and configured to carry a campaign model 402 including events corresponding to a campaign undertaken by a user 302.

In the embodiment 401, the success guidance engine 318 operates similarly to the description given above with respect to the embodiment 301, except that all or part of the success guidance engine 318, the campaign model 402 (carried as data on a computer readable medium) and the user interface software is all resident on the client computer 310 rather than residing on the server, as described in conjunction with the embodiment 301.

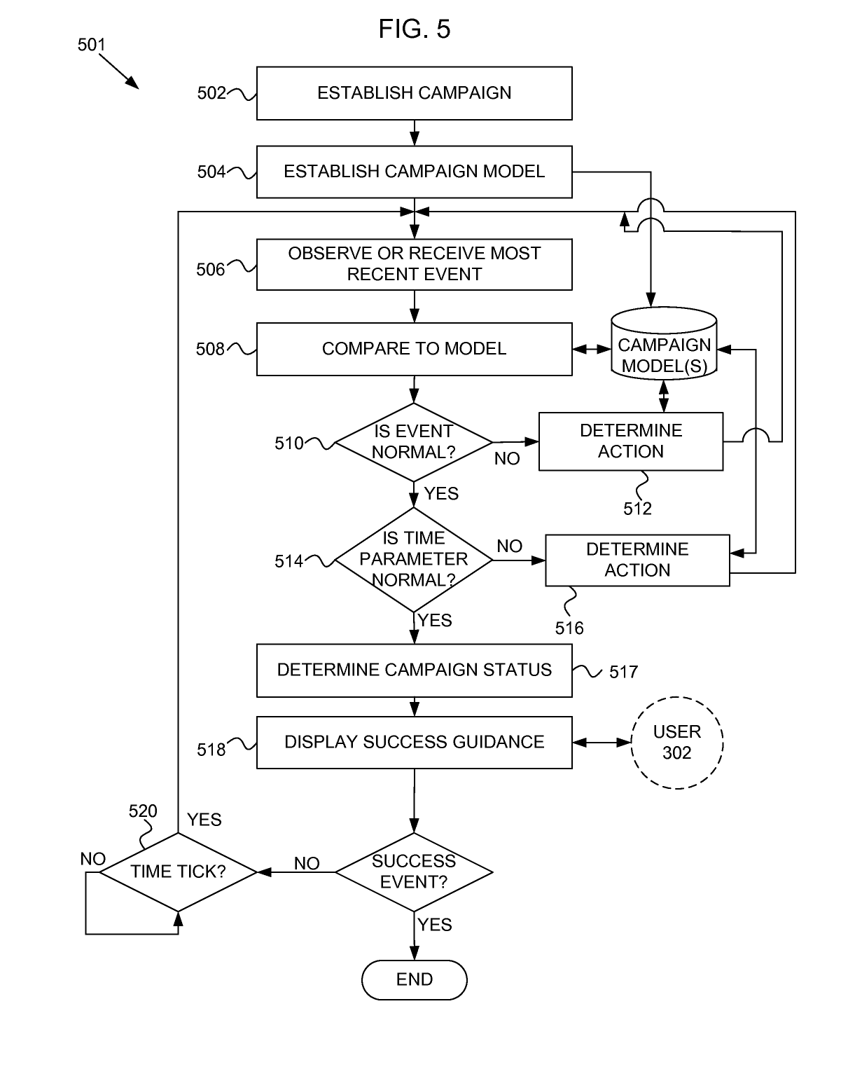

FIG. 5 is a flow chart showing a method 501 for providing success guidance to a user, according to an embodiment. The method 501 includes step 506, observing or receiving one or more reports of at least one event corresponding to a campaign. Proceeding to step 508, the observed or reported event(s) corresponding to the campaign is compared to corresponding model event(s) defined as steps in a campaign model. Proceeding further to step 518, success guidance based on compliance of the observed or reported event(s) to the model event(s) is displayed to the user via a graphical user interface.

The method 501 may additionally include step 502, establishing the campaign prior to observing or receiving a report of campaign event(s). Establishing the campaign may include, for example, receiving or sniffing a click or submitted inquiry from a customer or potential customer. In many campaign models, the receipt of data for establishing a campaign is considered part of the campaign model.

Step 504 includes establishing the campaign model corresponding to the campaign. For enterprises that sell or service product lines having a variety of sales cycles, for example, it may be advantageous to select a campaign model in step 504 after receiving an initial input that establishes the campaign. In this case, establishing a campaign model may include selecting the campaign model from a campaign model library. In other cases, for example enterprises that sell or service limited product lines or product lines having similar sales cycles, it may be advantageous to use the same campaign model for substantially every sales effort. In this case, establishing a campaign model in step 504 may include or consist essentially of referring to a fixed campaign model.

The step 506 of observing or receiving one or more reports of at least one event corresponding to the campaign can include receiving data communication corresponding to an independently verifiable event, and/or can include receiving data communication or user input corresponding to a non-independently verifiable event. (Independently verifiable and non-independently verifiable events are described above)

The campaign model established in step 504 includes at least one parameter, such as a time parameter, associated with each event or respective pairs of events. The time parameter can include an elapsed clock time, an elapsed calendar time, a scheduled clock time, a scheduled calendar date, or a seasonality-adjusted calendar date. As an illustrative example, a sales campaign model may include a pair of events “submit proposal” and “follow-up proposal”. The time parameter associated with this pair of events may be an elapsed calendar time such as three days, indicating that according to the model, a submitted proposal should be followed-up on three days after submitting the proposal. The time parameter may include a nominal range of times corresponding to a delay between events for a best path corresponding to the campaign model. Optionally, one or both of the events can be an alternative event lying on an alternative path to a success event. The alternative event(s) may include an action event, such as a follow-up to a proposal if a customer response is not received within a predetermined time after proposal submission.

According to an embodiment, method 501 can include step 520, wherein campaign event status is updated responsive to an elapsed time since actual execution corresponding to the previous event on the campaign model. Step 520 is depicted as part of the main loop of the flowchart of FIG. 5, but may be carried out in other ways, for example via a separate time tracking process running on a computer. Step 506, observing or receiving one or more reports of at least one event corresponding to the campaign, can also include observing or receiving a null report of an event. For example, a null report of an event can consist of elapsing of a maximum time since the previous campaign event without a report of the event. Processing null events may have advantages, for example allowing subsequent steps of method 501 to proceed without waiting for a non-null event to be observed or received at step 506.

Method 501 may additionally include decision step 510, determining if an event parameter a nominal range, and if so, proceeding to step 514. If the event parameter is outside the normal range, the process proceeds to step 512 where an action is determined. The action can include jumping to step 518 (jump not shown) to display success guidance. For example displaying success guidance can include pushing a notification to the user or otherwise displaying an indication of a deviation from normal. The action can alternatively include automatically loading an alternative campaign model including the alternative path or displaying recovery tips to the user.

Proceeding to step 514, if it is determined in step 514 that a time parameter is within a nominal range, the method maintains the current campaign model and proceeds to step 517. Maintaining the current campaign model can be substantially a null operation, realized by not loading an alternative campaign model. If, in step 514, it is determined that the time parameter is not within a normal range, the process proceeds to step 516, where an action is determined. The action can include jumping to step 518 (jump not shown) to display success guidance. For example displaying success guidance can include pushing a notification to the user or otherwise displaying an indication of a deviation from normal. The action can alternatively include automatically loading an alternative campaign model including the alternative path or displaying recovery tips to the user.

Each of the plurality of events in the campaign model of method 501 includes one or more event parameters. Every event includes a time parameter that relates to a completion time, either with respect to an elapsed time from a previous event along a completion path or with respect to an elapsed time with respect to duration of the event itself. Events may include other event parameters as well. For example, event parameters can include one or more of non-completion, completion, receipt, non-receipt, a quoted price, a margin corresponding to a quoted price, correspondence of content to content of a parameter of a previous event, and correspondence of content to model content.

Method 501 can include step 517, determining campaign status, which may include determining if a time parameter corresponding to a non-executed event corresponds to a recommendation to execute the non-executed event. For example, if a campaign model indicates that it is critical to send a follow-up email to a transmitted quotation within three days (a three-day “hard bar” time parameter), and it has been two days since the quotation was transmitted, the recommendation to execute the follow-up email may be made and, according to embodiments, may be emphasized in a user success guidance screen.

Additionally or alternatively, for a critical approaching date, displaying the success guidance may include transmitting an alert to the user via an out-of-band resource such as a text message, a synthesized voice transmission, an email, or other approach that bypasses a normal user interface. Determining campaign status in step 517 may include determining if an event parameter corresponding to an executed event corresponds to a recommendation to repeat the executed event or to modify the executed event. For example, if an executed event includes sending a quotation to a customer, but an actual event did not include a quote for an item in the quoted system, determining campaign status may include recommending augmenting the sent quotation with additional quote information about the excluded item.

Step 517 may include determining if executed event parameters and non-executed event time parameters fall within respective nominal ranges, and/or may include determining if an alternative campaign path, an alternative event, or an alternative campaign path and an alternative event are recommended.

Proceeding to step 518, method 501 may display success guidance to the user. Displaying success guidance may include loading a viewable page with one or more indicators of campaign success trajectory, one or more indicators of a next event, one or more indicators of a time parameter associated with a next event, or a combination thereof. Alternatively, displaying success guidance may include outputting to a user one or more indicators of campaign success trajectory, one or more indicators of a next event, one or more indicators of a time parameter associated with a next event, or a combination thereof. In some embodiments, displaying success guidance includes displaying one or more graphical health icons corresponding to compliance of actual campaign event and/or time parameters to corresponding model campaign parameters. Additionally or alternatively, one or more graphical comparisons of the actual campaign event placements to model campaign event placements may be displayed. Success guidance may also be displayed in some embodiments by displaying one or more text fields.

Step 518 can include displaying a graphical user interface to the user. Displaying the graphical user interface can include combining campaign status or deviations from the campaign model with the status or deviation from model of other campaigns. For example, FIG. 6 illustrates a graphical user interface that combines the status or deviations of plural campaigns. Additionally or alternatively, step 518 can include displaying a status or deviation of the particular campaign. FIG. 7 illustrates a graphical user interface that displays the status or deviation of a particular campaign.

The steps of method 501 are carried out by a computer. A non-transitory computer-readable medium such as, for example, a hard disk drive or flash drive, carries computer-executable instructions configured to execute the steps including observing or receiving one or more reports of at least one event corresponding to a campaign, comparing the at least one event corresponding to the campaign to a plurality of model events corresponding to a campaign model, and displaying success guidance based on compliance of the at least one event to the model events.

FIG. 6 is a depiction of a user HOME screen 601 displayed to a user of the success guidance software described above, according to an embodiment. After login to the computer application software, a user is presented with a home screen 601. Other tabs, including “ADMIN”, “NEW QUOTE”, “OPEN QUOTE”, and “TAKE ACTION” are shown displayed across the top of the screen, and provide shortcuts to access other program reporting screens and features.

The HOME screen 601 includes a user information window 602. The user information window 602 includes a welcome message 604, a user photo 606, and a user performance summary 608. The user photo 606 lets the user see the photo that will be displayed to customers in sales quotes displayed to customers. The user performance summary 608 includes a list of metrics for a current period and a previous period. For example, the user performance summary can include dollar value of quotes created, dollar value of quotes delivered (e.g., quotes posted on-line, with posting location transmitted to a customer), and dollar value of quotes won (e.g., sales made).

A NOTIFICATION window 610 includes push notifications 612a, 612b for campaign progress events. The push notifications 612a, 612b are displayed in order of receipt, with the newest notification 612a being inserted at the top of the list. Generally, notifications 612a, 612b pushed to the NOTIFICATION window 610 include independently verifiable events, described above, that are generated by verifiable user or customer interactions with the software system. The NOTIFICATION window 610 provides the user with a real time view of events associated with all active campaigns.

A TAKE ACTION window 614 includes summary information for active campaigns in an at-a-glance color-coded format that provides access to success guidance for campaigns at each of several success steps 616a, 616b, 616c. The particular success steps 616a, 616b, 616c listed in the TAKE ACTION window 614 are user-configurable according to defined steps to success for a typical campaign. For example, the example the TAKE ACTION window 614 includes a DELIVERED step 616a corresponding to on-line delivery of an electronic quote, a FIRST VISIT step 616b corresponding to a customer visit to the electronic quote, and an APPROVED step 616c corresponding to an electronic receipt of customer approval of the electronic quote. An icon above each step name provides a respective pictorial representation of the step. Status indicators 618a, 618b, 618c, 618d are respectively colored red, yellow, light green, and dark green when at least one active campaign is at a corresponding status. If no active campaign is at a respective status corresponding to an indicator 618a, 618b, 618c, 618d, then the status corresponding status indicator 618a, 618b, 618c, 618d is displayed grayed-out. By clicking on an “illuminated” status indicator 618a-d, the user receives a list of campaigns corresponding to the selected status. For example, a “red” status 618a in the DELIVERED step 616a indicates that the user is late in delivering an electronic quote to a customer for at least one campaign. A “yellow” status 618b in step 616a indicates that it is earlier than optimum for delivering an electronic quote to a user for at least one active campaign. A “light green” status 618c in step 616a indicates that at least one active campaign is in an early-but-acceptable timing for delivering an electronic quote to a customer. A “dark green” status 618d in step 616a indicates that at least one active campaign is within the optimum time window for delivering an electronic quote to a customer.

A RECENT QUOTE window 620 provides a listing of campaigns that fall within a selected status indicator 618a, 618b, 618c, 618d for a selected campaign step 616a, 616b, 616c.

An ACHIEVEMENT window 622 provides a display of “trophies” 624a, 624b, 624c gained by the user. The trophies can be generated according to default campaign success or can be assigned by the user's organization. In one embodiment, the trophies 624a, 624b, 624c are cumulative in that they indicate the user's historical success. In another embodiment, the trophies 624a, 624b, 624c are for a current period, for example the current day, week, month, quarter, or year. In another embodiment, the trophies 624a, 624b, 624c indicate instantaneous success. For example, a “bronze medal” 624a can indicate no campaigns correspond to a “red” status 618a for any success steps 616a, 616b, 616c that are under user control. A “silver medal” 624b can indicate that all success steps 616a, 616b, 616c, whether within the user's control or not, correspond to yellow, light green, or dark green indicators 618b, 618c, 618d. A “gold medal” 624c can indicate that all prior success steps 616a, 616b, 616c for every active campaign were performed while the corresponding status indicator 618d was in the “dark green” status.

The ACHIEVEMENT window 622 provides a game-like award mechanism for encouraging users to maximize their campaign “scores” (and thereby maximizing the organization's success).

FIG. 7 is a depiction of a campaign success guidance screen 701 displayed to a user of the success guidance software describe above, according to an embodiment. Across the top are tabs 702 corresponding to steps or stages in a campaign. The top portion 704 of the screen 701 is active corresponding to selection of the INITIAL SETUP tab 706. A campaign setup window 704 includes spaces for entry of campaign identity and parameters corresponding to the identified campaign. When a campaign is initiated by an on-line customer inquiry, at least some of the fields in the campaign setup window 704 can be pre-populated with customer-entered information. When a campaign is associated with an established customer, fields in the campaign setup window 704 can be populated from a customer database once a user enters the identity of the established customer. Alternatively, the user can enter fields in the campaign setup window 704 during a telephone or office interview with a prospective customer, or from notes made during an earlier customer interview.

After initial setup is performed, the campaign setup window 704 provides convenient information about a selected campaign. The campaign setup window 704 also provides pre-filled information for establishing additional campaigns for a given customer. For example, by clicking NEW VERSION, field information is copied into an INITIAL SETUP window 704 for a new campaign.

In the lower portion of the success guidance screen 701 is a campaign status window 708. The campaign status window 708 includes campaign step icons 710. By default, the campaign status window 708 opens with the pending campaign step 712a selected. The selected campaign step is displayed as a displayed campaign step icon 712b in a step status window 714. In the illustrative example 701, the selected campaign step 712a, 712b is FIRST VISIT, which refers to a customer's first viewing of an electronic quote at a secure or uncrawlable web address. The step status window 714 lists one or more target parameters 716 for the highest probability of campaign success. For example, the FIRST VISIT step 712 has a target date that is generated by the success guidance software as a function of parameters of earlier steps. In another example, a TOTAL VISITS step (which indicates the total number of customer visits to the proposal webpage) uses the number of webpage accesses as a target parameter.

A graphical target parameter indicator 718 provides a visual indicator of the campaign step status with respect to the one or more target parameters 716. In the example, the graphical target parameter indicator 718 includes a “clock” indicator 720 that “rotates” through four color-coded quadrants: a yellow EARLY quadrant 722, a dark green GREAT quadrant 724, a light green GOOD quadrant 726, and a red LATE quadrant 728. The durations per degree of the clock indicator 720 angle can be equal or can be nonlinear, depending on campaign and step sensitivity. For example, the graphical target parameter indicator 718 can be set up such that the most optimum target date aligns with the center of the GREAT quadrant 724. The top edge of the GREAT quadrant 724 can correspond to the earliest date at which a high probability of campaign success is indicated. The demarcation between the GREAT and GOOD quadrants 724, 726 can correspond to a date that has a statistically insignificant difference in outcome probability. The demarcation between the GOOD and LATE quadrants 726, 728 can be set at a date where campaign outcome is diminished sufficiently to justify taking an alternative set of steps (e.g., see alternative event 117 in FIG. 1).

The illustrative user interface screens 601, 701 of FIGS. 6 and 7 illustrate types of user feedback that are used. The inventors contemplate additional or alternative graphical user interfaces.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1.-62. (canceled)

63. A campaign success guidance computer method, comprising:
observing or receiving one or more reports of at least one event corresponding to a campaign;
comparing the at least one event corresponding to the campaign to a plurality of model events corresponding to a campaign model; and
displaying success guidance based on compliance of the at least one event to the model events.

64. The campaign success guidance computer method of claim 63, further comprising:
establishing the campaign.

65. The campaign success guidance computer method of claim 63, further comprising:
establishing the campaign model corresponding to the campaign.

66. The campaign success guidance computer method of claim 63, wherein at least a starting campaign model is fixed.

67. The campaign success guidance computer method of claim 63, wherein observing or receiving one or more reports of at least one event corresponding to the campaign includes receiving data communication corresponding to a verifiable event.

68. The campaign success guidance computer method of claim 63, wherein observing or receiving one or more reports of at least one event corresponding to the campaign includes receiving data communication or user input corresponding to a non-verifiable event.

69. The campaign success guidance computer method of claim 63, wherein the campaign model includes a time parameter associated with respective pairs of events.

70. The campaign success guidance computer method of claim 69, wherein the time parameter includes one or more selected from the group consisting of an elapsed clock time, an elapsed calendar time, a scheduled clock time, a scheduled calendar date, a seasonality-adjusted calendar date.

71. The campaign success guidance computer method of claim 69, wherein the time parameter includes a nominal range of times corresponding to a delay between events for a best path corresponding to the campaign model.

72. The campaign success guidance computer method of claim 69, wherein the time parameter includes a nominal range of times corresponding to a delay between events, wherein at least one of the events is an alternative event lying on an alternative path to the success event.

73. The campaign success guidance computer method of claim 72, wherein the at least one alternative event includes an action event.

74. The campaign success guidance computer method of claim 63, further comprising:
updating campaign events received or reported responsive to an elapsed time.

75. The campaign success guidance computer method of claim 63, wherein observing or receiving one or more reports of at least one event corresponding to the campaign includes observing or receiving a report of a null event.

76. The campaign success guidance computer method of claim 75, further comprising:
determining if a time parameter is outside a nominal range;
determining an alternative path if the time parameter is outside the nominal range; and
loading an alternative campaign model including the alternative path.

77. The campaign success guidance computer method of claim 63, further comprising:
determining if a time parameter is within a nominal range; and
maintaining the current campaign model if the time parameter is within the nominal range.

78. The campaign success guidance computer method of claim 63, wherein the plurality of events in the campaign model each include one or more event parameters.

79. The campaign success guidance computer method of claim 78, wherein the one or more event parameters include one or more selected from the group consisting of non-completion, completion, receipt, non-receipt, a quoted price, a margin corresponding to a quoted price, correspondence of content to content of a parameter of a previous event, and correspondence of content to model content.

80. The campaign success guidance computer method of claim 63, further comprising:
determining if an event parameter is within a nominal range; and
maintaining the current campaign model if the event parameter is within the nominal range.

81. The campaign success guidance computer method of claim 63, further comprising:
determining if an event parameter is outside a nominal range;
determining an alternative path if the event parameter is outside the nominal range; and
loading an alternative campaign model including the alternative path.

82. The campaign success guidance computer method of claim 63, further comprising:
determining campaign status.

83. The campaign success guidance computer method of claim 82, wherein determining campaign status includes determining if a time parameter corresponding to a non-executed event corresponds to a recommendation to execute the non-executed event.

84. The campaign success guidance computer method of claim 82, wherein determining campaign status includes determining if an event parameter corresponding to an executed event corresponds to a recommendation to repeat the executed event or to modify the executed event.

85. The campaign success guidance computer method of claim 82, wherein determining campaign status includes determining if executed event parameters and non-executed event time parameters fall within respective nominal ranges.

86. The campaign success guidance computer method of claim 82, wherein determining campaign status includes determining if an alternative campaign path, an alternative event, or if an alternative campaign path and an alternative event are recommended.

87. The campaign success guidance computer method of claim 63, wherein displaying success guidance includes loading a viewable page with one or more indicators of campaign success trajectory, one or more indicators of a next event, one or more indicators of a time parameter associated with a next event, or a combination thereof.

88. The campaign success guidance computer method of claim 63, wherein displaying success guidance includes outputting to a user one or more indicators of campaign success trajectory, one or more indicators of a next event, one or more indicators of a time parameter associated with a next event, or a combination thereof.

89. The campaign success guidance computer method of claim 63, wherein displaying success guidance includes displaying one or more graphical health icons corresponding to compliance of actual campaign event parameters to corresponding model campaign event parameters.

90. The campaign success guidance computer method of claim 63, wherein displaying success guidance includes displaying one or more graphical health icons corresponding to compliance of actual campaign time parameters to corresponding model campaign time parameters.

91. The campaign success guidance computer method of claim 63, wherein displaying success guidance includes displaying one or more graphical comparisons of the actual campaign event placements to model campaign event placements.

92. The campaign success guidance computer method of claim 63, wherein displaying success guidance includes displaying one or more text fields.

93. A non-transitory computer-readable medium carrying computer-executable instructions configured to execute the steps comprising:
observing or receiving one or more reports of at least one event corresponding to a campaign;
comparing the at least one event corresponding to the campaign to a plurality of model events corresponding to a campaign model; and
displaying success guidance based on compliance of the at least one event to the model events.

94. The non-transitory computer-readable medium carrying computer-executable instructions configured to execute the steps of claim 93, wherein the computer executable instructions are further configured to execute a step comprising:
establishing the campaign.

95. The non-transitory computer-readable medium carrying computer-executable instructions configured to execute the steps of claim 93, wherein the computer executable instructions are further configured to execute a step comprising:
establishing the campaign model corresponding to the campaign.

96. The non-transitory computer-readable medium carrying computer-executable instructions configured to execute the steps of claim 93, wherein at least a starting campaign model is fixed.

97. The non-transitory computer-readable medium carrying computer-executable instructions configured to execute the steps of claim 93, wherein observing or receiving one or more reports of at least one event corresponding to the campaign includes receiving data communication corresponding to a verifiable event.

98. The non-transitory computer-readable medium carrying computer-executable instructions configured to execute the steps of claim 93, wherein observing or receiving one or more reports of at least one event corresponding to the campaign includes receiving data communication or user input corresponding to a non-verifiable event.

99. The non-transitory computer-readable medium carrying computer-executable instructions configured to execute the steps of claim 93, wherein the campaign model includes a time parameter associated with respective pairs of events.

100. The non-transitory computer-readable medium carrying computer executable instructions configured to execute the step of claim 99, wherein the time parameter includes one or more selected from the group consisting of an elapsed clock time, an elapsed calendar time, a scheduled clock time, a scheduled calendar date, and a seasonality-adjusted calendar date.

101. The non-transitory computer-readable medium carrying computer executable instructions configured to execute the step of claim 99, wherein the time parameter includes a nominal range of times corresponding to a delay between events for a best path corresponding to the campaign model.

102. The non-transitory computer-readable medium carrying computer executable instructions configured to execute the step of claim 99, wherein the time parameter includes a nominal range of times corresponding to a delay between events, wherein at least one of the events is an alternative event lying on an alternative path to the success event.

103. The non-transitory computer-readable medium carrying computer executable instructions configured to execute the step of claim 102, wherein the at least one alternative event includes an action event.

104. The non-transitory computer-readable medium carrying computer executable instructions configured to execute the step of claim 93, wherein the computer executable instructions are further configured to execute a step comprising:
updating campaign events received or reported responsive to an elapsed time.

105. The non-transitory computer-readable medium carrying computer executable instructions configured to execute the steps of claim 93, wherein observing or receiving one or more reports of at least one event corresponding to the campaign includes observing or receiving a report of a null event.

106. The non-transitory computer-readable medium carrying computer executable instructions configured to execute the step of claim 105, wherein observing or receiving one or more reports of at least one event corresponding to the campaign includes observing or receiving a report of a null event wherein the computer executable instructions are further configured to execute steps comprising:
determining if a time parameter is outside a nominal range;
determining an alternative path if the time parameter is outside the nominal range; and
loading an alternative campaign model including the alternative path.

107. The non-transitory computer-readable medium carrying computer executable instructions configured to execute the steps of claim 93, wherein the computer executable instructions are further configured to execute steps comprising:
determining if a time parameter is within a nominal range; and
maintaining the current campaign model if the time parameter is within the nominal range.

108. The non-transitory computer-readable medium carrying computer executable instructions configured to execute the steps of claim 93, wherein the plurality of events in the campaign model each include one or more event parameters.

109. The non-transitory computer-readable medium carrying computer executable instructions configured to execute the step of claim 108, wherein the one or more event parameters include one or more selected from the group consisting of non-completion, completion, receipt, non-receipt, a quoted price, a margin corresponding to a quoted price, correspondence of content to content of a parameter of a previous event, and correspondence of content to model content.

110. The non-transitory computer-readable medium carrying computer executable instructions configured to execute the steps of claim 93, wherein the computer executable instructions are further configured to execute steps comprising:
determining if an event parameter is within a nominal range; and
maintaining the current campaign model if the event parameter is within the nominal range.

111. The non-transitory computer-readable medium carrying computer executable instructions configured to execute the steps of claim 93, wherein the computer executable instructions are further configured to execute steps comprising:
determining if an event parameter is outside a nominal range;
determining an alternative path if the event parameter is outside the nominal range; and
loading an alternative campaign model including the alternative path.

112. The non-transitory computer-readable medium carrying computer executable instructions configured to execute the steps of claim 93, wherein the computer executable instructions are further configured to execute a step comprising:
determining campaign status.

113. The non-transitory computer-readable medium carrying computer executable instructions configured to execute the step of claim 112, wherein determining campaign status includes determining if a time parameter corresponding to a non-executed event corresponds to a recommendation to execute the non-executed event.

114. The non-transitory computer-readable medium carrying computer executable instructions configured to execute the step of claim 112, wherein determining campaign status includes determining if an event parameter corresponding to an executed event corresponds to a recommendation to repeat the executed event or to modify the executed event.

115. The non-transitory computer-readable medium carrying computer executable instructions configured to execute the step of claim 112, wherein determining campaign status includes determining if executed event parameters and non-executed event time parameters fall within respective nominal ranges.

116. The non-transitory computer-readable medium carrying computer executable instructions configured to execute the step of claim 112, wherein determining campaign status includes determining if an alternative campaign path, an alternative event, or if an alternative campaign path and an alternative event are recommended.

117. The non-transitory computer-readable medium carrying computer executable instructions configured to execute the steps of claim 93, wherein displaying success guidance includes loading a viewable page with one or more indicators of campaign success trajectory, one or more indicators of a next event, one or more indicators of a time parameter associated with a next event, or a combination thereof.

118. The non-transitory computer-readable medium carrying computer executable instructions configured to execute the steps of claim 93, wherein displaying success guidance includes outputting to a user one or more indicators of campaign success trajectory, one or more indicators of a next event, one or more indicators of a time parameter associated with a next event, or a combination thereof.

119. The non-transitory computer-readable medium carrying computer executable instructions configured to execute the steps of claim 93, wherein displaying success guidance includes displaying one or more graphical health icons corresponding to compliance of actual campaign event parameters to corresponding model campaign event parameters.

120. The non-transitory computer-readable medium carrying computer executable instructions configured to execute the steps of claim 93, wherein displaying success guidance includes displaying one or more graphical health icons corresponding to compliance of actual campaign time parameters to corresponding model campaign time parameters.

121. The non-transitory computer-readable medium carrying computer executable instructions configured to execute the steps of claim 93, wherein displaying success guidance includes displaying one or more graphical comparisons of the actual campaign event placements to model campaign event placements.

122. The non-transitory computer-readable medium carrying computer executable instructions configured to execute the steps of claim 93, wherein displaying success guidance includes displaying one or more text fields.
